(19) United States
(12) Patent Application Publication
(10) Pub. No.: US 2013/0149103 A1
(43) Pub. Date: Jun. 13, 2013

(54) BALLISTIC MATERIALS FOR ENHANCED ENERGY ABSORPTION AND FAN CASINGS INCLUDING THE SAME

(71) Applicants: James F. Stevenson, Morristown, NJ (US); Richard Bye, Morristown, NJ (US); Bill Russell Watson, Scottsdale, AZ (US); Barrett Joseph Fuhrmann, Gilbert, AZ (US); Martin Carlin Baker, Budd Lake, NJ (US)

(72) Inventors: James F. Stevenson, Morristown, NJ (US); Richard Bye, Morristown, NJ (US); Bill Russell Watson, Scottsdale, AZ (US); Barrett Joseph Fuhrmann, Gilbert, AZ (US); Martin Carlin Baker, Budd Lake, NJ (US)

(73) Assignee: HONEYWELL INTERNATIONAL INC., Morristown, NJ (US)

(21) Appl. No.: 13/314,924

(22) Filed: Dec. 8, 2011

(51) Int. Cl. F01D 25/24; B32B 3/04; D03D 15/00

(52) U.S. Cl. 415/9; 442/185; 442/181; 428/121

(57) ABSTRACT

Ballistic materials for enhanced energy absorption and fan casings for turbine engines including the same are provided. A hybrid ballistic material comprises a first ballistic fabric and at least one individual member woven through at least a portion of the first ballistic fabric. The fan casing comprises at least one layer of a first crushable material circumscribing a fan containment case. A ballistic material comprising a net-like ballistic material or the hybrid ballistic material circumscribes the at least one layer of the first crushable material. At least one layer of a second crushable material may circumscribe the ballistic material with the ballistic material disposed between the at least one layer of the first and second crushable materials. A containment covering is an outermost layer of the fan casing.

### TECHNICAL FIELD

The present invention generally relates to ballistic materials, and more particularly relates to ballistic materials for enhanced energy absorption and fan casings including the same.

### BACKGROUND

Modern aircraft are often powered by a propulsion system that includes a gas turbine engine housed within an aerodynamically streamlined nacelle. A fan section of the gas turbine engine includes a fan assembly and a fan containment case. The fan assembly includes a fan rotor hub centered on and rotatable about an axially extending centerline of the engine, and a plurality of fan blades that are attached to and extend radially out from the fan rotor hub. The fan containment case is disposed radially outside of and circumferentially around the fan assembly. The high-energy impact of a broken fan blade (commonly referred to as “blade out”) on an operating gas turbine engine can be undesirable. If the broken fan blade is not isolated from the rotating fan assembly, the broken fan blade can interfere with the remaining blades during their deceleration. A fan casing for the fan containment case captures the broken blade, preventing the broken blade from penetrating the engine housing while providing a space for the broken blade outside of the rotation path of the remaining blades.

Fan casings must be as lightweight as possible for aircraft operating efficiency, yet provide the critical level of protection against the threats posed by a broken fan blade, taking into account all the requirements, including space limitations, of the engine nacelle. Conventional fan casings include a stiff but crushable honeycomb material and a containment covering comprising a lightweight, high strength, and plain weave ballistic fabric wrapped in multiple layers around the honeycomb material. The conventional containment covering has no folds. The edges of the conventional containment covering are typically constrained around the fan containment case by bonding or the like, but axially oriented fibers in the containment covering ballistic material may have unanchored cut ends.

During normal operation, the honeycomb material provides stiffness to the fan containment case. When a fan blade breaks in flight, the broken blade penetrates the fan containment case and strikes the honeycomb material. The honeycomb material deflects radially and crushes under the immense centrifugal force of the broken blade to provide a blade capture pocket for capturing the broken blade, thereby isolating the broken blade from the rotating fan assembly. However, due to limited energy absorption by the honeycomb material, the high energy impact of the broken blade crushes the honeycomb material locally, causing undesirable loss of the stiffening capability of the honeycomb material.

The containment covering in the fan casing resists penetration by the broken blade and confines the broken blade to a predetermined circumferential envelope in the engine nacelle. When the broken blade impacts the containment covering in the conventional fan casing, because of the high friction between the continuous fabric layers making up the containment covering and the edge constraints thereof, the broken blade stretches the containment covering in a local region with energy absorption limited to that region, resulting in local deformation and damage at the impact location only, with possible breakthrough of the circumferential envelope by the broken blade and out of the engine nacelle. Therefore, many more continuous layers of fabric than necessary are used for the containment covering to ensure critical containment of the broken blade within the circumferential envelope and engine nacelle. Such over engineering results in excess material usage and weight, as well as cost inefficiencies. For example, a conventional containment covering of Kevlar® plain weave ballistic fabric may undesirably account for 25% or more of the weight of the fan casing for engines in which it is used. In addition, the edges of the conventional containment covering are subject to delamination as well as pullout upon high-energy impact of the broken blade. As used herein, the term “delamination” means the separation of adjacent fabric layers and the term “pullout” refers to pulling out of the axially oriented fibers having unanchored cut ends at the edge of the ballistic fabric.

Accordingly, it is desirable to provide ballistic materials for enhanced energy absorption and fan casings including the same. In addition, it is desirable to enable the use of less ballistic fabric in the containment covering of the fan casing, thereby reducing the weight and cost thereof for increased aircraft operating efficiency. It is also desirable to minimize delamination and pullout of the containment covering. Furthermore, other desirable features and characteristics of the present invention will become apparent from the subsequent detailed description of the invention and the appended claims, taken in conjunction with the accompanying drawings and this background of the invention.

### BRIEF SUMMARY

Hybrid ballistic materials are provided in accordance with one exemplary embodiment. The hybrid ballistic material comprises a first ballistic fabric and at least one individual member woven through at least a portion of the first ballistic fabric.

Fan casings for fan containment cases in turbine engines are also provided in accordance with another exemplary embodiment of the present invention. The fan casing comprises at least one layer of a first crushable material circumscribing the fan containment case. A layer of ballistic material comprising one of a net-like ballistic material and a hybrid ballistic material circumscribes the at least one layer of the first crushable material. A containment covering is an outermost layer.

Containment coverings of fan casings for fan containment cases in turbine engines are also provided in accordance with another exemplary embodiment of the present invention. The containment covering comprises a plurality of continuous fabric layers of a multi-layered longitudinally or diagonally folded structure. Each of the multi-layered longitudinally or diagonally folded structures comprises a sheet of foldable ballistic fabric having two parallel spaced longitudinal edges, the sheet of foldable ballistic fabric successively folded at a selected angle. The containment covering further comprises at least one restraining member.

Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a plan view of an exemplary net-like ballistic material, in accordance with exemplary embodiments;

FIG. 2 is a plan view of an exemplary hybrid ballistic material comprised of normally wrapped individual members woven in a predetermined pattern of horizontal filling lines into a first ballistic fabric with a standard weave style, according to another exemplary embodiment of the present invention;

FIG. 3 is a plan view similar to FIG. 2 of another exemplary hybrid ballistic material comprised of normally wrapped individual members woven in a predetermined pattern of horizontal filling lines into a first ballistic fabric with a standard weave style with alternative member-to-member spacing, according to another exemplary embodiment of the present invention;

FIG. 4 is a plan view similar to FIGS. 2 and 3 of another exemplary hybrid ballistic material comprised of normally wrapped individual members woven in a predetermined pattern of horizontal filling lines into a first ballistic fabric with a standard weave style and offset “stitches”, according to another exemplary embodiment of the present invention;

FIG. 5 is a plan view similar to FIGS. 2 through 4 of another exemplary hybrid ballistic material comprised of a spiral wrapped individual member woven in a spiral pattern into a first ballistic fabric with a standard weave style;

FIG. 6 is a plan view similar to FIGS. 2 through 5 of another exemplary hybrid ballistic material comprised of a spiral wrapped individual member woven in a spiral pattern into a first ballistic fabric with an offset standard weave style;

FIG. 7 is a simplified diagrammatic illustration of an embodiment of a gas turbine engine including a fan section that includes a fan assembly and a fan containment case, the engine disposed within a nacelle of an aircraft with a fan casing disposed radially outside and circumferentially around the fan containment case;

FIG. 8 is a schematic illustration of the fan casing of FIG. 7 circumscribing the outside of the fan containment case, according to exemplary embodiments;

FIG. 9 is a schematic fold diagram of an exemplary sheet of foldable second ballistic fabric with dotted longitudinal fold lines for forming an exemplary multi-layered longitudinally folded structure (an exemplary trifold structure) of a containment covering for the fan casing of FIG. 8, according to exemplary embodiments;

FIG. 10A is a side view of the exemplary multi-layered longitudinally folded trifold structure formed by folding the sheet of foldable second ballistic fabric of FIG. 9, according to exemplary embodiments;

FIG. 10B is a side view of an exemplary multi-layered longitudinally folded quadfold structure having no exposed edges;

FIG. 11A is a schematic illustration of a foldable sheet of second ballistic fabric with a first diagonal fold, in accordance with exemplary embodiments;

FIG. 11B is a schematic fold diagram of the foldable sheet of second ballistic fabric of FIG. 11A, illustrated a partially folded structure with dashed diagonal fold lines for forming an exemplary multi-layered diagonally folded structure of the containment covering for the fan casing of FIG. 8, according to exemplary embodiments, the partially folded structure including a pair of restraining members within the folds thereof;

FIG. 11C is a table providing fold dimensions for an exemplary multi-layered diagonally folded structure;

FIGS. 12 through 15 illustrate an assembly sequence of a fan casing around the fan containment case, the fan casing including the hybrid ballistic material of FIGS. 2-6, according to exemplary embodiments;

FIG. 16 is a schematic illustration of the fan containment case circumscribed by a layer of first crushable material and a layer of second crushable material that are bonded together and to both primary and secondary load paths with the net-like ballistic material of FIG. 1 disposed therebetween forming a bonded assembly of a partially-assembled fan casing, according to another exemplary embodiment;

FIGS. 17 through 18 are representative schematic illustrations of the bonded assembly of FIG. 16 after impact of a broken fan blade, with FIG. 18 also including a containment covering; and

FIG. 19 is a representative schematic sectional view of the fan casing of FIG. 8 (the bonded assembly has been omitted for ease of illustration), showing stretching of the containment covering of FIG. 18 with the force (indicated by arrows) of the broken blade transferring energy around the circumference of the fan casing; and

FIG. 20 is a schematic top view of the fan casing of FIG. 8 (the bonded assembly has been omitted for ease of illustration), showing stretching of the containment covering of FIG. 19.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Various embodiments are directed to ballistic materials for improved energy absorption and fan casings including the same. A fan casing is disposed radially outside and circumferentially around a fan containment case of a turbine engine to protect against threats posed by a broken fan blade from a fan assembly of the engine. The turbine engine may be disposed within a nacelle of an aircraft. As used herein, the term “ballistic materials” is inclusive of “ballistic fabrics” and means a material or fabric resistant to penetration by a high velocity projectile such as a broken fan blade, shrapnel, a bullet or the like. As used herein, the term “broken blade” includes the entire blade or a blade fragment and includes a single broken blade or a plurality of broken blades. According to exemplary embodiments, the ballistic material may be a net-like ballistic material formed from a plurality of individual members or a hybrid ballistic material. The hybrid ballistic material comprises at least one individual member woven into at least a portion of a first ballistic fabric. The fan casing comprises at least one layer of a first crushable material and optionally, at least one layer of a second crushable material. If the at least one layer of the first crushable material and the at least one layer of the second crushable material are used, the ballistic material may be disposed therebetween. At least the layers of the first and second crushable material that are immediately adjacent the ballistic material are at last partially bonded together at selected locations to form a bonded assembly. Other layers of the at least one layer of the first and second crushable materials may also be bonded together and to a primary and a secondary load path of the fan containment case. At least a portion of the ballistic material is unconstrained in the bonded assembly and is free to stretch for enhanced energy absorption to isolate the broken blade from a rotating fan assembly disposed inside the fan containment case. The fan casing further comprises a containment covering for containing the broken blade within a circumferential envelope of the engine nacelle. In an embodiment, the containment covering comprises a second ballistic fabric folded into a multi-layered longitudinally folded structure or a multi-layered diagonally folded structure (referred to collectively as “multi-layered folded structures”) that is continuously wrapped in a plurality of continuous layers radially outside and circumferentially around the outermost layer of the second crushable material. The multi-layered folded structures comprised of the second ballistic fabric are exemplary “ballistic materials for enhanced energy absorption.” In other embodiments, the containment covering for use with the net-like ballistic material or the hybrid ballistic material comprises the conventional containment covering. As noted above and known to one skilled in the art, the conventional containment covering comprises a lightweight, high strength, and plain weave ballistic fabric. The conventional containment covering, when used in a fan casing comprising the net-like ballistic material or the hybrid ballistic material, is wrapped in multiple continuous layers around the outermost layer of the second crushable material. The edges of the second ballistic fabric forming the conventional containment covering are restrained by bonding or the like against the outermost layer of the second crushable material. The conventional containment covering has no folds and may have unanchored cut ends. In other embodiments, the containment covering comprises combinations of the multi-layered longitudinally folded structure, the multi-layered diagonally folded structure, and the conventional containment covering. According to exemplary embodiments, the net-like and hybrid ballistic materials stretch primarily circumferentially, providing enhanced energy absorption. The containment covering in accordance with exemplary embodiments also provides enhanced energy absorption, while including less ballistic fabric than conventional containment coverings, thereby reducing the weight and cost of the fan casing relative to fan casings including conventional containment coverings. Additionally, the folding of the second ballistic fabric into the multi-layered folded structures of the containment covering substantially minimizes delamination and pullout of the axially oriented fibers having the unanchored cut ends at the edges of the second ballistic fabric upon high-energy impact of the broken blade. As noted above, the term “delamination” means the separation of adjacent fabric layers.

While the advantages of the ballistic materials for enhanced energy absorption as described herein will be described with reference for inclusion in a fan casing for a fan containment case of a turbine engine in an aircraft, the teachings of the present invention include use of the net-like and hybrid ballistic materials to protect people and/or critical systems from high energy projectiles other than broken blades, such as bullets, shrapnel, or the like and for applications other than in a fan casing. For example, the net-like and hybrid ballistic materials may be used as or in protective armor for an aircraft fuselage, for an automobile, or the like. The net-like and hybrid ballistic materials may be tailored to specific threats posed by the specific high energy projectile. Additionally, the containment covering according to exemplary embodiments may be used in conventional fan casings and fan casings in accordance with exemplary embodiments as described herein for enhanced energy absorption and to reduce the weight and cost thereof.

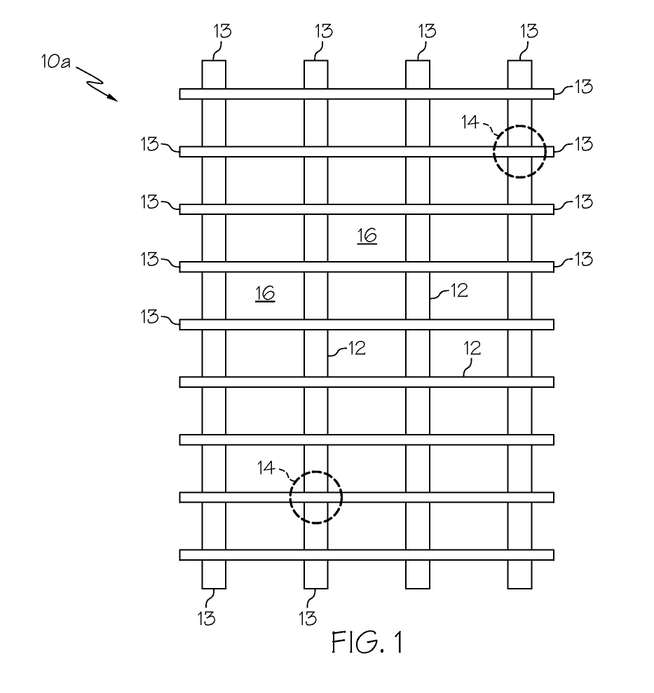

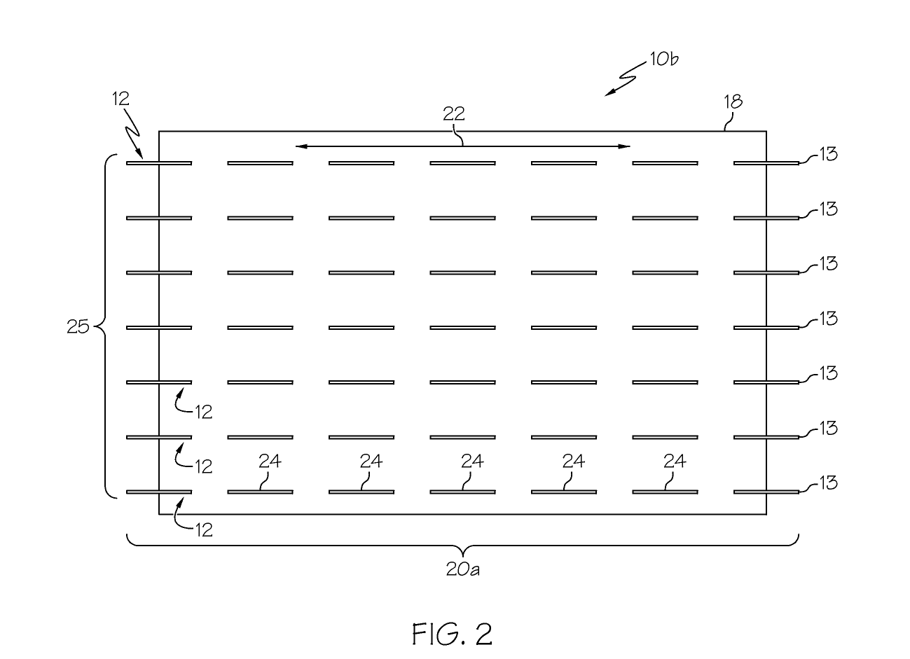

According to exemplary embodiments, referring to FIGS. 1 and FIGS. 2-6, the ballistic material comprises a net-like ballistic material 10a (FIG. 1) or a hybrid ballistic material 10b (FIGS. 2-6). The net-like ballistic material 10a comprises an open mesh ballistic material made by linking a plurality of individual members 12 together at regular or irregular intervals. The individual members 12 may be individual lengths of fabric strips, twine, wire, tape, cable, cord, rope, or the like (hereinafter referred to as “individual member types”) that are formed from lightweight, high strength materials. The individual lengths have opposing ends 13. As used herein, the term “lightweight” means a density of less than approximately 1.5 g/cc and the term “high strength” means materials having a tensile strength greater than about 3,000 MPa such as, for example, Kevlar® aramid rope or tape. The individual members intersect other individual members at crossover points 14. The intersecting individual members may be bonded or linked together at the crossover points 14 by mechanical, chemical, or thermal means, or combinations thereof. An exemplary chemical bonding agent includes a thermoplastic elastomer but other chemical bonding agents as known in the art may be used. Mechanical bonding includes knotting the individual members together. While linking of a plurality of individual members is described, it is to be understood that a single continuous individual member may alternatively be used to form the net-like ballistic material. The individual members provide concentrated reinforcement to the ballistic material, as hereinafter described. By the link connections of the individual members, the net-like ballistic material 10a can be folded or rolled up for storage without problems.

The exemplary net-like ballistic material 10a illustrated in FIG. 1 is formed from individual members 12 that are arranged horizontally in parallel spaced-apart relation to each other to intersect with a plurality of individual members arranged vertically and in parallel spaced-apart relation to each other. The member-to-member spacing is the same throughout the exemplary net-like ballistic material of FIG. 1. Each of the horizontal individual members intersect and is linked with each of the vertical individual members at the crossover points 14 to form the exemplary net-like ballistic material 10a of FIG. 1 having square mesh openings 16 of the same size. As noted above, the net-like ballistic material 10a may be tailored to specific threats posed by the specific high energy projectile. For example, it is to be understood that such variables as the spacing between individual members (i.e., the member-to-member spacing), individual member cross sectional area and shape, individual member material, individual member tension, and/or individual member linking, etc. of the net-like ballistic material 10a may be different than the net-like ballistic material illustrated in FIG. 1. As one example only, the horizontal individual members may be one individual member type (i.e., fabric strips, twine, wire, tape, cable, cord, rope, or the like) and the vertical horizontal members may be a different individual member type or the horizontal individual members may be of mixed-type and the vertical individual members may be of mixed type, that is the same or different than the mixed type of the horizontal individual members. In addition, as another example, an individual member may comprise more than one individual member type or material. If the net-like ballistic material covers a cylindrical surface, a single continuous individual member may be used in the circumferential direction in a spiral pattern. All the above variables may also vary with location in the net-like ballistic material. The properties of the net-like ballistic material may be isotropic or anisotropic with different materials or dimensions providing the net-like ballistic material with different properties in different directions.

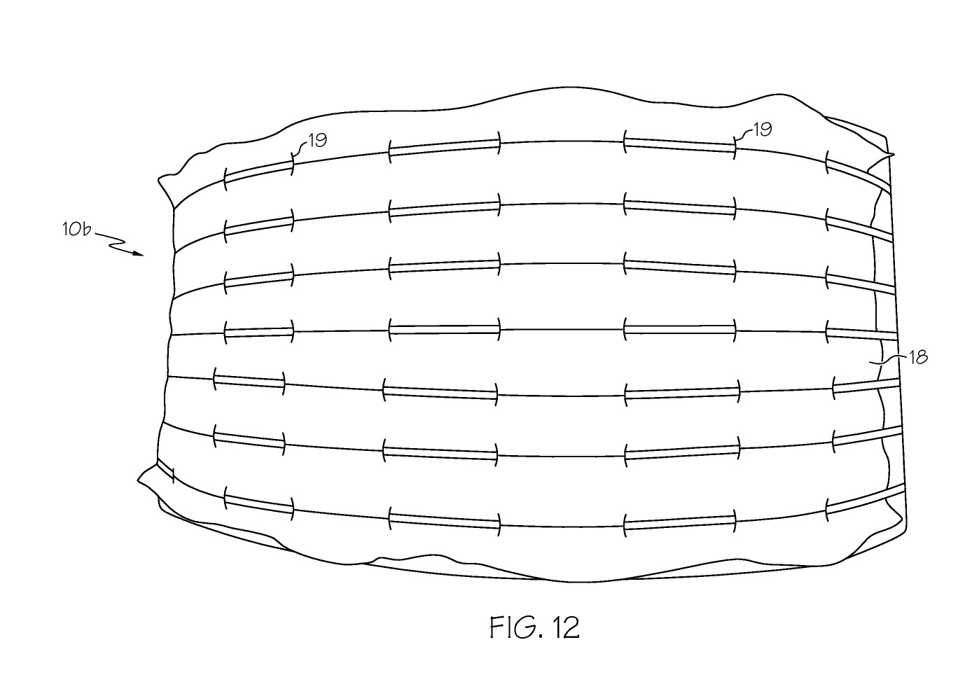

Referring now to FIGS. 2-6, in other exemplary embodiments, the hybrid ballistic material 10b comprises at least one of the individual members 12 woven into a first ballistic fabric 18. As used herein, the term “hybrid” refers to the combination of the individual member(s) 12 and the first ballistic fabric 18 that differ in form on a macroscale. The at least one individual member may be woven through a plurality of openings 19 (See FIG. 12) formed by cutting, etc. in the first ballistic fabric 18 (the openings 19 not shown in FIGS. 2 through 6) or in the weave of the fabric, if present as hereinafter described. A predetermined number of individual members are associated with the first ballistic fabric. The individual member(s) may be woven into a portion of or all of the first ballistic fabric. The mechanical integrity of the hybrid ballistic material 10b is maintained and concentrated reinforcement provided to the first ballistic fabric by the mechanical interlocking of the woven individual member(s) with the first ballistic fabric. The hybrid ballistic material 10b is faster and easier to manufacture than the net-like ballistic material 10a as it is unnecessary to link individual members together, as the first ballistic fabric provides the link. The at least one individual member 12 is woven into the first ballistic fabric 18 in a predetermined pattern with a predetermined weave style. Some of the more common weave styles are plain, twill, satin, basket, leno and mock leno as known in the art. The plain or standard weave style consists of the individual member passing over a portion of the first ballistic fabric and under an adjacent portion of the first ballistic fabric at various intervals forming a plurality of stitches 24 that together form a filling line 20a or 20b. As used herein, the term “stitch” means a loop of the individual member.

The first ballistic fabric 18 may be a woven or a nonwoven ballistic fabric. As used herein, a “fabric” is defined as a manufactured assembly of long fibers to produce a flat sheet of one or more layers of fibers. These layers are held together either by mechanical interlocking of the fibers themselves or with a secondary material to bind these fibers together and hold them in place, giving the assembly sufficient integrity to be handled. Fabric types are categorized by the orientation of the fibers, and by the various construction methods used to hold the fibers together. The four main fiber orientation categories are unidirectional, 0/90°, multiaxial, and random. Any fiber orientation category may be used in the first ballistic fabric.“Ballistic fabrics” are lightweight with high tensile strength and resist penetration by high velocity projectiles. As noted above, the term “lightweight” means a density of less than approximately 1.5 g/cc and the term “high strength” means materials having a tensile strength greater than about 3,000 MPa. Energy absorption for ballistic fabrics in terms of fiber material properties is proportional to the Young's modulus (stiffness) of the fibers multiplied by the square of the elongation to break. Hence ballistic fabrics having fibers with higher values of this product are preferred, such as values in the range of about 70 Gpa or more to about 3.6% or more for elongation to break.

Woven ballistic fabrics are produced by the interlacing of warp fibers and weft fibers in a regular pattern or weave style. The fabric integrity is maintained by the mechanical interlocking of the fibers. Exemplary suitable woven first ballistic fabrics include, for example, Spectra® material available from Honeywell International Inc, and Kevlar® 29 and Kevlar® 49 aramid fabrics available from E. I. du Pont de Nemours and Company (Wilmington, Del., USA). Exemplary suitable nonwoven first ballistic fabrics include, for example, Spectra Shield® material available from Honeywell International Inc.

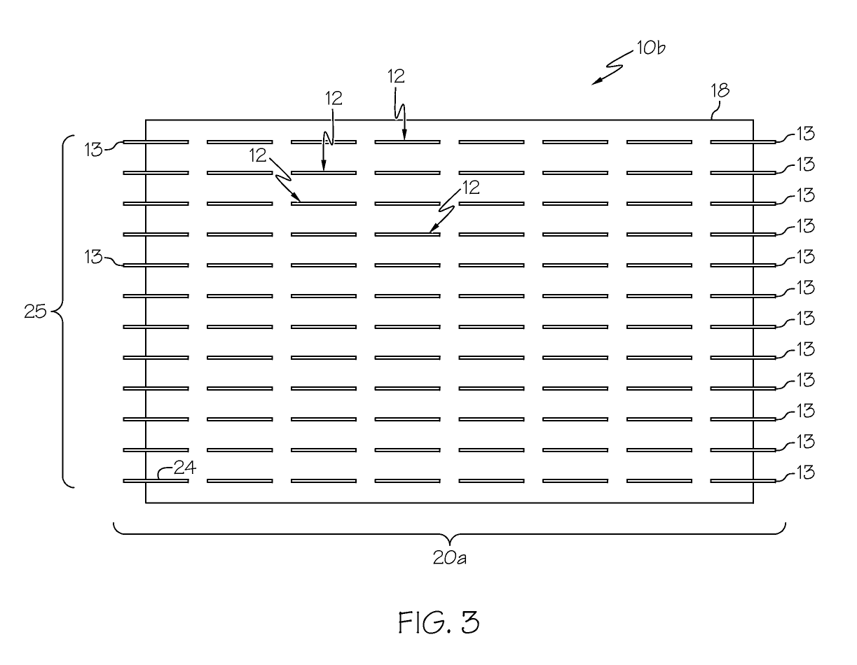

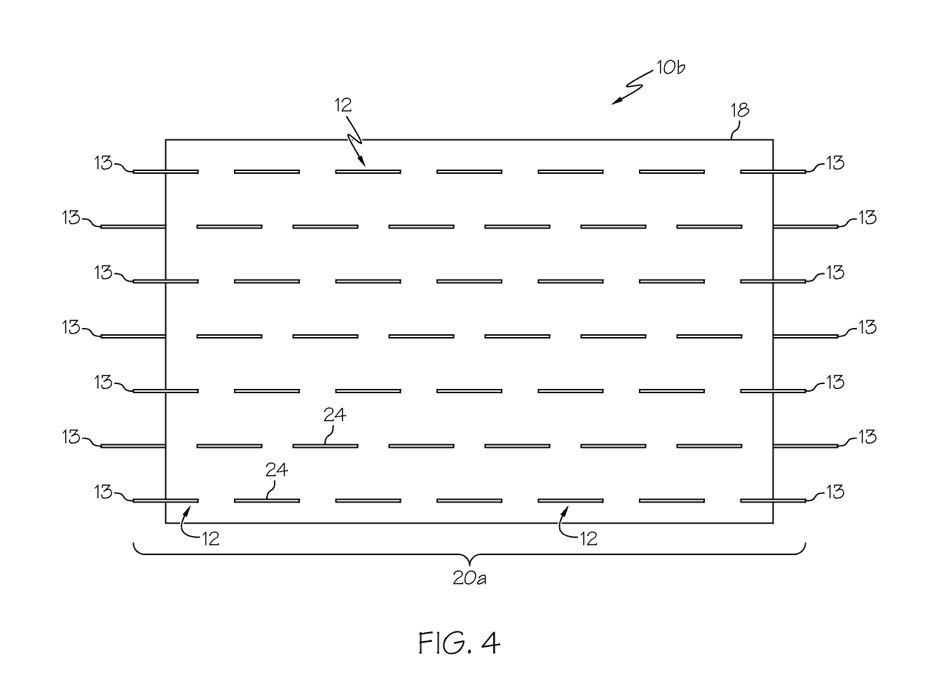

Referring now specifically to FIGS. 2 through 4, in accordance with exemplary embodiments, the at least one individual member 12 comprises a plurality of individual members woven in a “normal wrap pattern” with a plain weave style. The normal wrap pattern comprises a plurality of horizontal filling lines 20a made by the plurality of woven individual members 12, the horizontal filling lines parallel to a lengthwise grain (indicated by double-headed arrow 22) (FIG. 2) of the first ballistic fabric. The stitches 24 of the parallel horizontal filling lines 20a may form a uniform column 25 in the first ballistic fabric 18 (FIGS. 2 and 3), or be offset from one another (FIG. 4) (i.e., the stitches of each horizontal filling line 20a are offset from the stitches in the horizontal filling line immediately below, the horizontal filling line immediately above, or both). FIGS. 2 and 3 illustrate a normal wrap pattern, a plain weave style, and the stitches of different horizontal filling lines in the uniform column 25. FIG. 3 differs from FIG. 2 in the spacing and density of the horizontal filling lines. FIG. 4 illustrates a normal wrap pattern and a plain weave style having offset stitches.

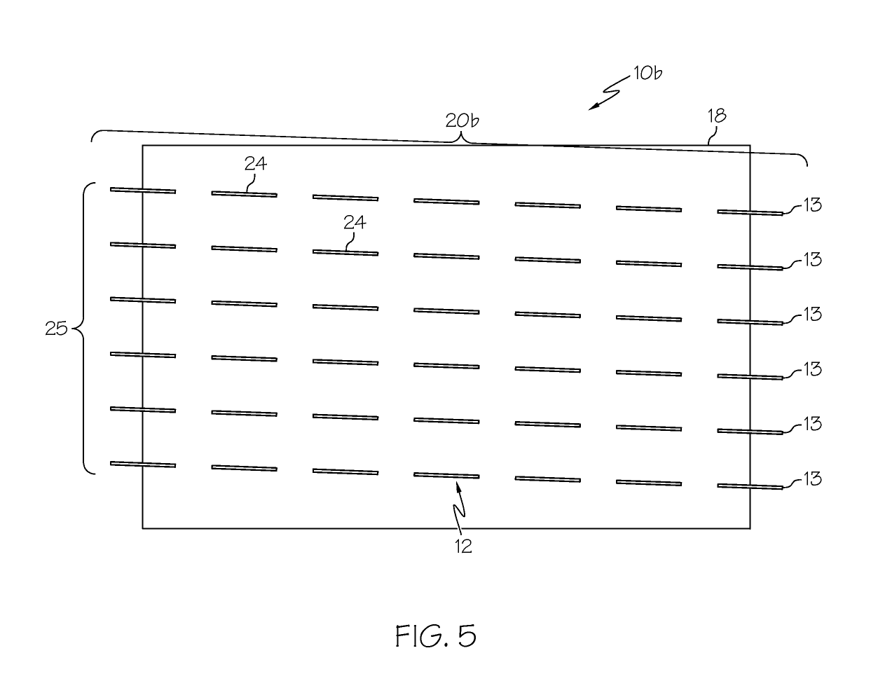

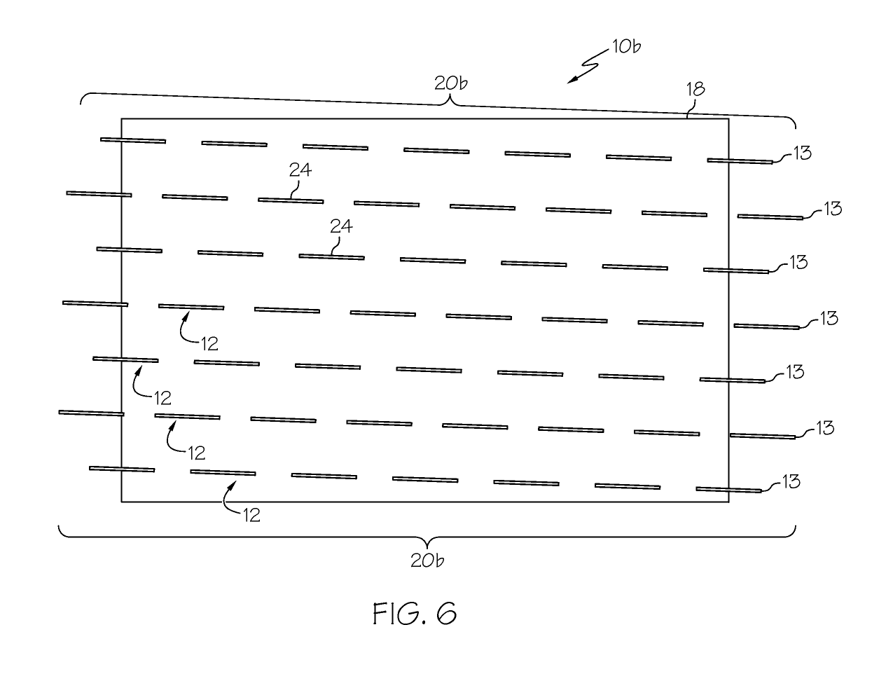

Referring now to FIGS. 5 and 6, according to other exemplary embodiments, a single, elongated individual member may be woven through the first ballistic fabric 18 in a continuous “spiral wrap pattern” in non-horizontal filling lines 20b. The length of the single, elongated individual member depends, for example, on the spacing of the non-horizontal filling lines and the circumference of the fan containment case. The stitches 24 in FIG. 5 form the uniform column 25 in the first ballistic fabric 18 and the stitches 24 of FIG. 6 are offset. It is to be understood that the predetermined patterns, predetermined weave styles, member-to-member spacing, and weave densities other than those illustrated and described may be used for the hybrid ballistic material 10b. For example, the individual members 12 may be woven into the first ballistic fabric 18 in any number of predetermined patterns to provide concentrated reinforcement to the first ballistic fabric. For example, the predetermined pattern may comprise the plurality of individual members intersecting with each other to form a net-like array. It is also possible to arrange the individual members in the first ballistic fabric according to an arrangement of discrete filling areas and disposed in an arbitrary pattern relative to each other.

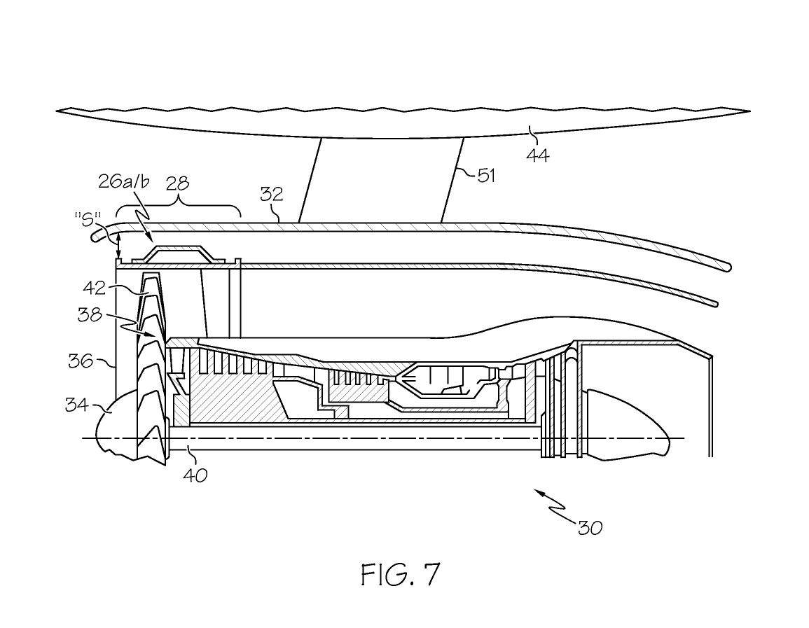

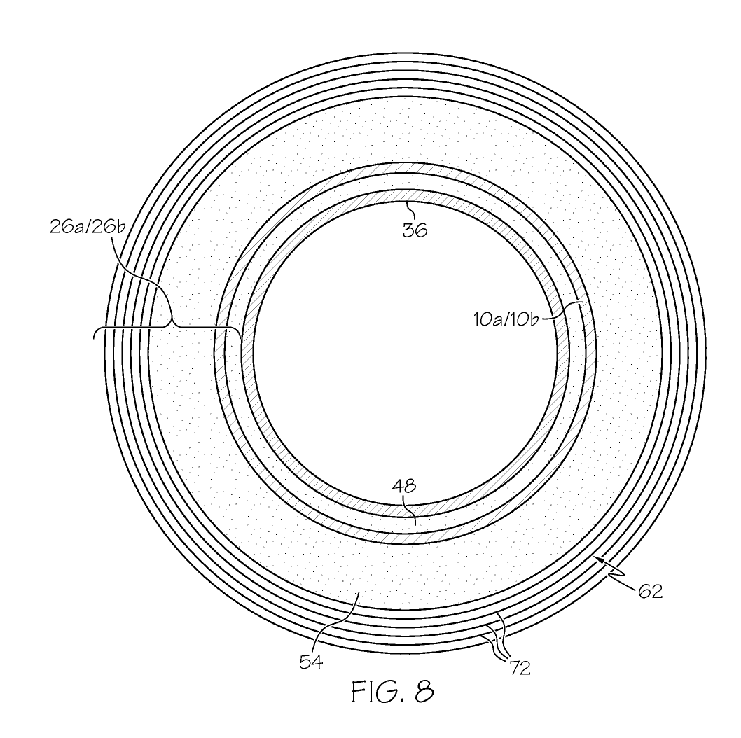

Referring again to FIGS. 1 through 6 and now to FIGS. 7 through 8, as noted above, the net-like ballistic material 10a (FIG. 1) may be used in a fan casing 26a (FIG. 8) or the hybrid ballistic material 10b (FIGS. 2 through 6) may be used in a fan casing 26b (FIG. 8) in a fan section 28 of a gas turbine engine 30. FIG. 7 is a diagrammatic illustration of an embodiment of a gas turbine engine 30 (hereinafter the “engine”). The engine is attached via a pylon structure 51 to a fuselage or wing of the aircraft 44 (shown schematically). When the engine that includes the fan casing is installed on an aircraft 44, the engine is part of the propulsion system that includes an aerodynamically streamlined nacelle 32 that substantially surrounds the engine 30. The forward portion of the nacelle circumscribes and is radially spaced from the fan casing forming a predetermined circumferential envelope. It is desirable for the radial spacing S between the fan casing and the nacelle to be as small as possible to minimize the weight and bulk of the propulsion system. The present invention is not limited to any particular engine type or nacelle configuration. The fan section 28 of the engine 30 includes a fan assembly 34 and a fan containment case 36. The fan assembly 34 includes a fan rotor hub 38 centered on and rotatable about an axially extending centerline 40 of the engine 30, and a plurality of fan blades 42 that are attached to and extend radially out from the fan rotor hub. The fan containment case 36 is disposed radially outside of and circumferentially around the fan assembly 34. The fan containment case 36 can be constructed (e.g., by molding and/or machining) from lightweight materials including, for example, aluminum, titanium and/or composites. The fan containment case 36 is located within the engine nacelle 32 of the aircraft 44. The fan casings 26a and 26b are designed to withstand the high-energy impact of a broken blade 46 (not shown in FIG. 7 or 8), ejected when the fan assembly 34 is operating at a high rotational speed.

Referring still to FIG. 8, in accordance with exemplary embodiments, the fan casing 26a or 26b for the fan containment case 36 of the turbine engine comprises at least one layer of a first crushable material 48 circumscribing the fan containment case 36. The ballistic material 10a for fan casing 26a and ballistic material 10b for fan casing 26b circumscribes the outermost layer of the at least one layer of the first crushable material 48. In an embodiment, the at least one layer of the first crushable material 48 is a single layer and the ballistic material circumscribes the single layer of the first crushable material 48.

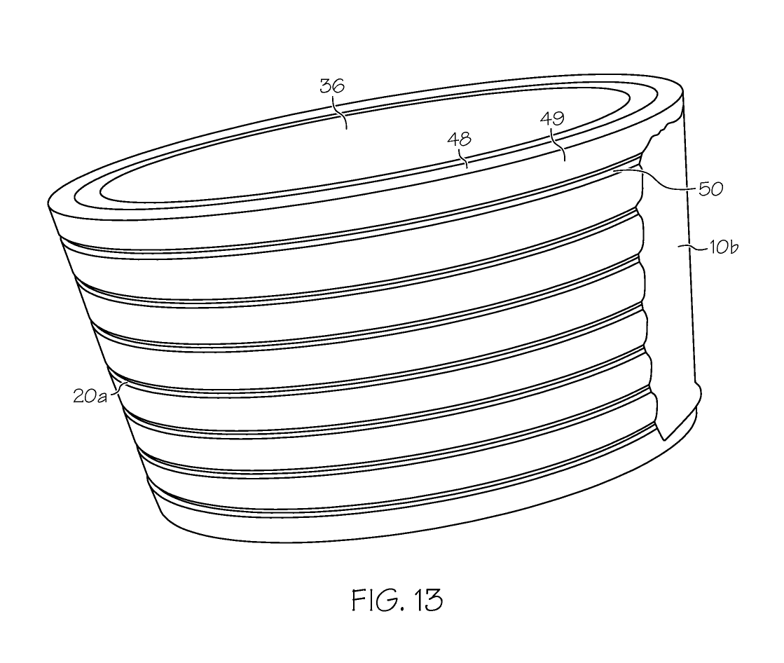

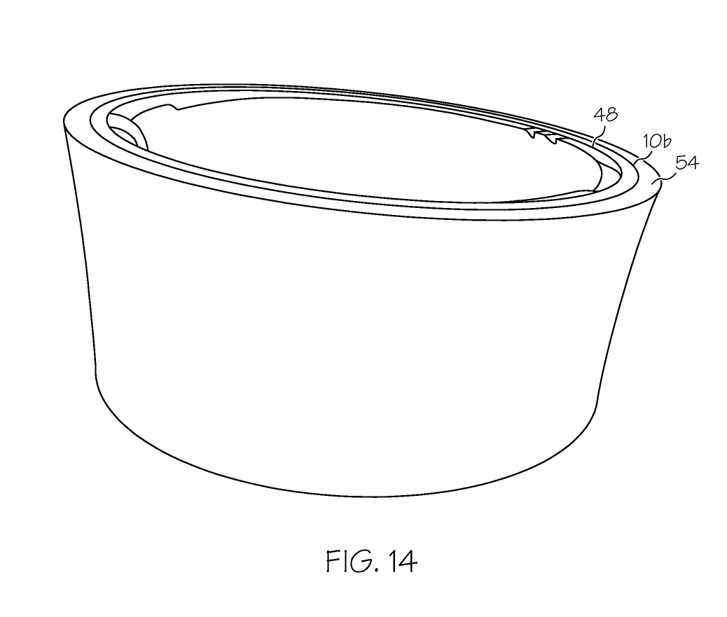

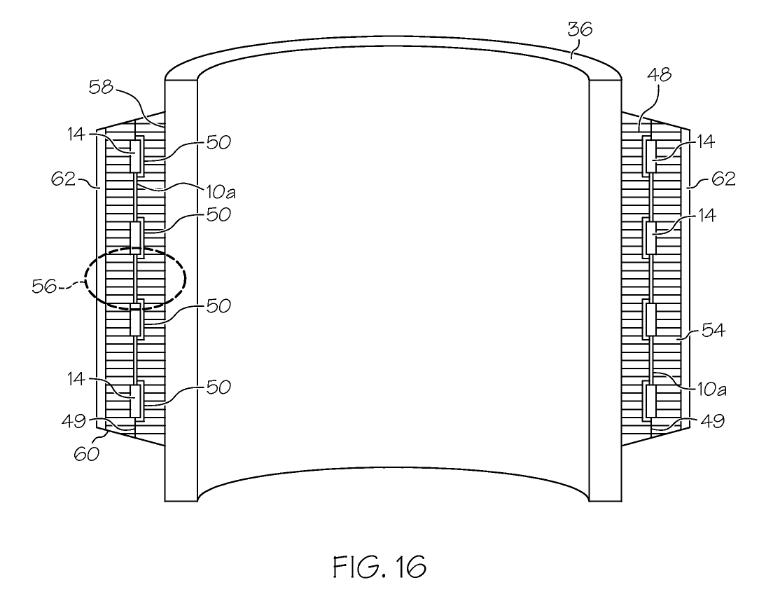

In an embodiment, as illustrated in FIG. 8, at least one layer of a second crushable material 54 circumscribes the ballistic material 10a or 10b with the ballistic material 10a/10b disposed in a mid plane (an inner bonding surface 49) between the outermost layer of the at least one layer of the first crushable material and the innermost layer of the at least one layer of the second crushable material 48 and 54. The at least one layer of the first crushable material 48 and the at least one layer of the second crushable material comprise honeycomb material, such as aluminum honeycomb material, or polyurethane and other foams, or the like. The first and second crushable materials may be the same or different. While not shown in FIG. 8, but shown in FIG. 16 for fan casing 26a and in FIGS. 13 and 14 for fan casing 26b, at least the layers of the first and second crushable material that are immediately adjacent the ballistic material (referred to herein as “adjacent layers”) are bonded together at selected locations to form a bonded assembly to provide energy absorption as well as to provide stiffening of the fan casing during normal operation. The selected locations include bonding through the mesh openings of the ballistic material. Other layers of the at least one layer of the first and second crushable materials may also be bonded together and to a primary and a secondary load path of the fan containment case. At least a portion of the ballistic material is unconstrained in the bonded assembly, for purposes as hereinafter described. Known bonding methods include, for example, the use of a bonding agent. At least one horizontal groove 50 (See, for example, FIG. 13) in defined in the outermost layer of the at least one layer of the first crushable material or the innermost layer of the at least one layer of the second crushable material, i.e., one of the adjacent layers, for purposes as hereinafter described. The at least one groove 50 may be formed in the inner bonding surface 49 by a milling process or another process.

A containment covering 62, in its entirety, comprises the outermost layer of the fan casing. In an embodiment, the containment covering 62 circumscribes the outermost layer of the at least one layer of second crushable material. In a preferred embodiment, a top portion extends beyond the top edges of the underlying layers, a bottom portion extends beyond the bottom edges of the underlying layers, or both. The underlying layers comprise the at least one layer of first crushable material, the ballistic material, and the at least one layer of second crushable material. The top and/or bottom portions of the containment covering may conform over the top and bottom edges of underlying layers in a known “hat-shape” configuration.

In another embodiment, the second crushable material 54 is optional and the containment covering 62 circumscribes the ballistic material. The layers underlying the containment covering in this case are, from the inside out, the at least one layer of first crushable material and the ballistic material. The at least one layer of first crushable material can be a single layer, as noted above.

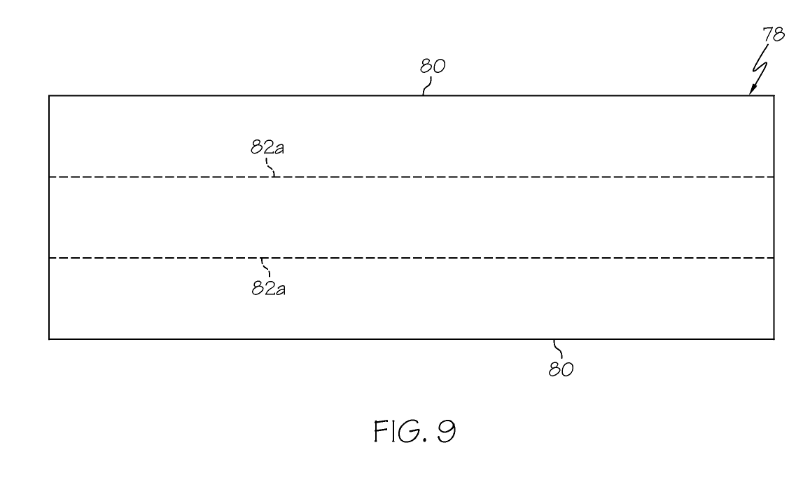

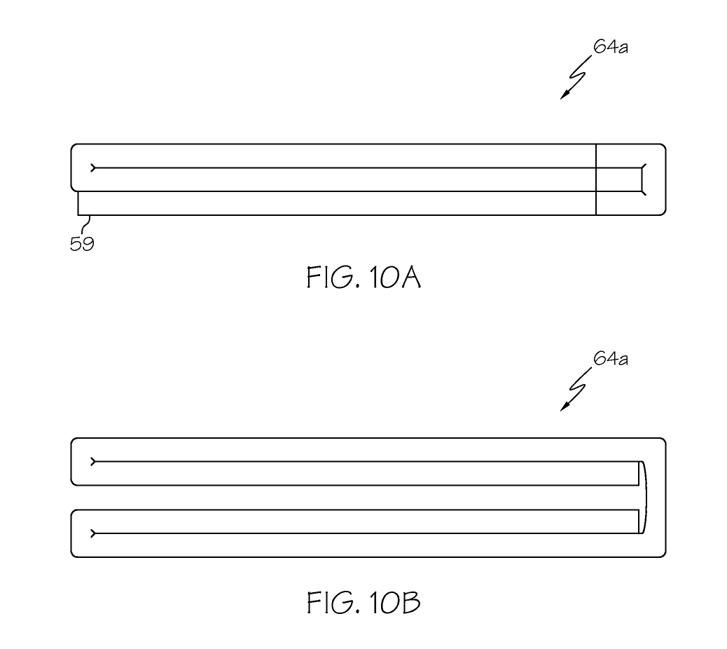

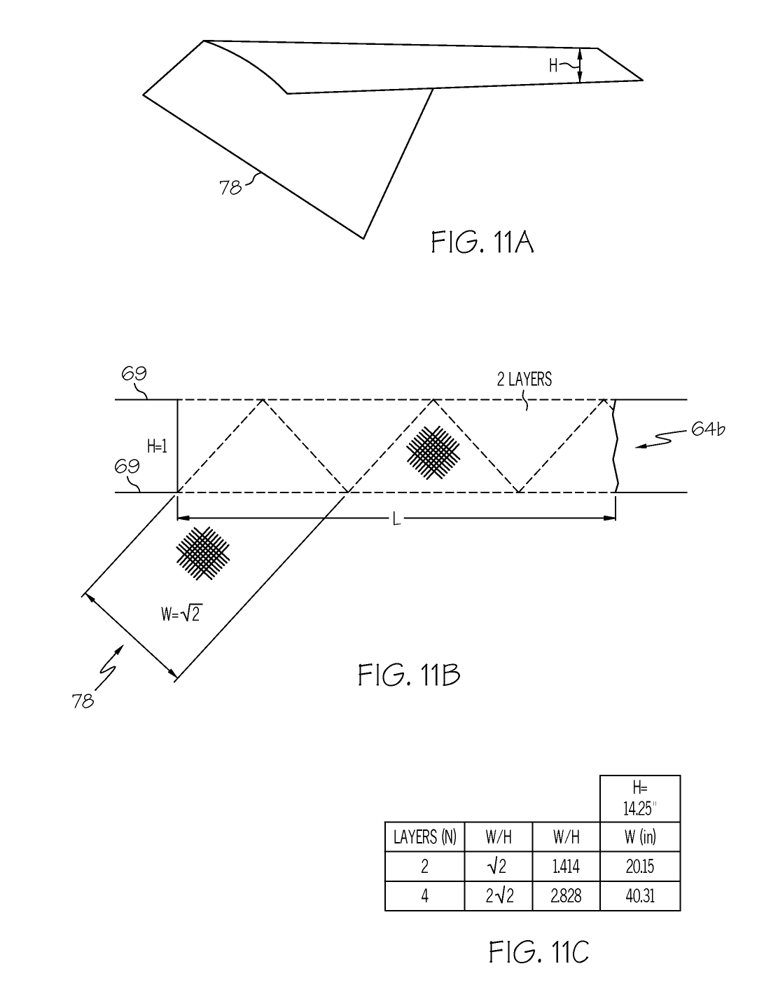

In accordance with exemplary embodiments, the containment covering 62 comprises a plurality of continuous fabric layers of a multi-layered longitudinally folded structure 64a (See FIGS. 10A and 10B for exemplary multi-layered longitudinally folded structures, as hereinafter described), a multi-layered diagonally folded structure 64b (See FIGS. 11A and 11B), or a combination thereof. Still referring to FIG. 8 and now to FIGS. 9 through 11C, according to exemplary embodiments, the containment covering 62 (FIG. 8) comprising the multi-layered longitudinally and/or diagonally folded structures 64a and 64b (FIGS. 10A and 10B and FIGS. 11A and 11B, respectively) is formed from a sheet of foldable second ballistic fabric 78. Like the first ballistic fabric, the foldable second ballistic fabric 78 may be a woven or a nonwoven ballistic fabric. The first and second ballistic fabrics may be the same or different. Exemplary suitable woven second ballistic fabrics include, for example, Spectra® material available from Honeywell International Inc. and Kevlar® 29 and Kevlar® 49 aramid fabrics available from E. I. du Pont de Nemours and Company (Wilmington, Del., USA). Exemplary suitable nonwoven second ballistic fabrics include, for example, Spectra Shield® material available from Honeywell International Inc.

Referring now specifically to FIG. 9 and FIGS. 10A and 10B, the sheet of foldable second ballistic fabric 78 has two parallel spaced longitudinal edges 80 and a plurality of longitudinal fold lines 82a (indicated as dotted lines). For example, the sheet of foldable second ballistic fabric 78 illustrated in FIG. 9 has two longitudinal fold lines. The number of longitudinal fold lines is equal to M-1, wherein M is the desired number of folds. The sheet of foldable second ballistic fabric may be folded at the longitudinal fold lines into the multi-layered longitudinally folded structure 64a. In accordance with exemplary embodiments, the multi-layered longitudinally folded structure 64a may be formed by folding the sheet of foldable second ballistic fabric 78 at the longitudinal fold lines 82a extending parallel to the longitudinal edges 80 of the sheet and uniformly spaced therefrom. Once folded at the longitudinal fold lines, the sheet of folded second ballistic fabric forms the multi-layered longitudinally folded structure 64a having a number of folds (M=number of folds). FIG. 10A illustrates an exemplary multi-layered longitudinally folded trifold structure (M=3) having one exposed edge 59 formed from the sheet of foldable second ballistic fabric 78 having two longitudinal fold lines illustrated in FIG. 9. FIG. 10B illustrates an exemplary multi-layered longitudinally folded quadfold structure (M=4) having no exposed edges, i.e., the edges are tucked inside the structure. The multi-layered longitudinally folded structure preferably has no exposed edges or a minimum number of exposed edges to substantially prevent delamination or pullout. It is to be understood that the multi-layered longitudinally folded structures 64a may be formed with a greater or lesser number of layers, folds, fold widths than as described herein. The friction between the layers of the multi-layered longitudinally folded structure 64a (FIGS. 10A and 10B) and the continuous layers (FIG. 8) of the containment covering preferably have a kinetic coefficient of friction of less than about 0.4 for purposes as hereinafter described. The second ballistic fabric for the containment covering comprising the multi-layered longitudinally folded structure may be selected on the basis of an inherently lower friction. For example, Kevlar® 29 ballistic fabric has inherently low friction. The friction may alternatively or also be reduced by low friction additives such as, for example, Teflon powder, oriented satin weaves, etc. as known in the art.

Referring now to FIGS. 11A through 11B, in accordance with other exemplary embodiments, the sheet of folded second ballistic fabric may be folded diagonally into the multi-layered diagonally folded structure 64b (exemplary partially folded multi-layered diagonally folded structures at various stages of folding are shown in FIGS. 11A and 11B). The plurality of diagonal folds forms a helical fold pattern. The exemplary multi-layered diagonally folded structure 64b illustrated in FIG. 11B (shown as partially folded) may be formed by diagonally folding the sheet of second ballistic fabric 78 on the true bias of the sheet of second ballistic fabric. As known in the art, grain refers to the straight and crosswise direction of the fibers making up a woven fabric, with bias running at any angle to the straight and crosswise grains and the true bias running at a 45-degree angle. The multi-layered diagonally folded structure 64b is produced by locating the true bias of the second ballistic fabric by diagonally folding an edge of the second ballistic fabric so that the lengthwise fibers are lined up with the crosswise fibers forming an original diagonal fold line at the true bias as illustrated in FIG. 11B. The diagonal fold lines are all at the true bias, i.e., at a 45 degree angle to the lengthwise grains and crosswise grains. The successive diagonal fold lines are parallel to the original diagonal fold line and spaced apart a predetermined distance corresponding to the desired fold width. For folding on a true bias angle of 45°, the width (H) of the multi-layered diagonally folded structure with two layers is related to the width (W) of the sheet 78 by the ratio of H=W/√2 (See FIG. 11B). For a fold angle (a “specified bias angle”) of 45°, the relation between the number of layers (N), the width of the sheet 78 (W), and the width of the multi-layered diagonally folded structure (H) is provided for the first fold by the following equation:

W=(N/2)√2H.

The number N of layers for a true bias angle of 45° must be an even number (2, 4, etc.) so the number of layers is uniform over the folded surface.

For more than two layers (N>2), the value of H in the above equation will increase with each successive fold to maintain the bias angle at 45° because of overlap of the finite thickness of the folded material at the fold line. The overall length (L) of the multi-layered diagonally folded structure for a bias angle of 45° and an even number of layers N when the change in H due to the overlap is ignored is provided by:

L=(F−1)H, where F is the number of folds.

The length L can be through of as the circumference of the folded structure wrapped around a cylinder and closed along a 45° angle. It is to be understood that the multi-layered diagonally folded structures 64b may be formed with a greater or lesser number of layers, folds, fold widths, and with other fold angles than as described herein.

FIG. 11C is a table identifying fold dimensions for an exemplary multi-layered diagonally folded structure, in accordance with exemplary embodiments. The example is provided for illustration purposes only, and is not meant to limit the various embodiments of the present invention in any way.

Folding of the sheet of second ballistic fabric into the multi-layered longitudinally folded structure 64a or the multi-layered diagonally folded structure 64b results in an increase in the energy absorption per unit areal density of the containment covering relative to conventional containment coverings. As known in the art, energy absorption is calculated by subtracting the kinetic energy of a projectile exiting the containment covering as hereinafter described from the kinetic energy of the projectile impacting the containment covering. The areal density is the weight of the containment covering divided by its area at the innermost radius. In addition to increasing the energy absorption per unit areal density of the containment covering, longitudinal folds substantially prevent the broken blade from escaping above and below the containment covering (i.e., beyond the top and bottom edges thereof). Diagonal folds reduce pullout upon high energy impact of the broken blade, as hereinafter described. For example, a woven second ballistic fabric combining 0 and 90 degree fiber orientations (commonly referred to as “a 0/90° fabric”) is particularly benefitted by diagonal folding. Without diagonal folding, the 90° fibers may pull out and the circumferential 0° fibers may break because they are stretched tightly and cannot shift relative to each other. By folding the 0/90° second ballistic fabric diagonally to form a multi-layered diagonally folded structure, the fibers in the multi-layered diagonally folded structure become oriented at +/−45 degrees relative to the length thereof (as shown in FIG. 11B). In addition, because the diagonal folds are along a bias edge of the 0/90° second ballistic fabric, delamination of the outer layer of fibers is substantially prevented. In the case of diagonally folded second ballistic fabric, friction between individual layers of the multi-layered diagonally folded structures may be desired to inhibit the individual layers from sliding over each other and thereby excessively elongating and deflecting the containment covering as hereinafter described.

The containment covering comprising the multi-layered longitudinally folded structure 64a or the multi-layered diagonally folded structure 64b may optionally further comprise at least one restraining member 69 (illustrated with the multi-layered diagonally folded structure 64b of FIG. 11B). The at least one restraining member 69 may be incorporated between the folds and/or layers of the multi-layered longitudinally or diagonally folded structures as illustrated in FIG. 11B. Preferably the at least one restraining member is incorporated in the penultimate and/or final folds/layers. The at least one restraining member comprises at least one relatively stiff strap made of nylon or the like, cable ties, etc. that under prescribed tension, allows the highest possible energy absorption while substantially preventing unwinding of the multi-layered longitudinally or diagonally folded structure. The at least one restraining member is adapted to wrap around the multi-layered longitudinally or diagonally folded structure at the top edge thereof, the bottom edge thereof, or both. Free ends of the at least one restraining member may be secured in a manner known to one skilled in the art. The at least one restraining member may be anchored between the folds/layers by anchoring means well known in the art. The length of the at least one restraining member corresponds to the circumference around the outermost layer of the containment covering.

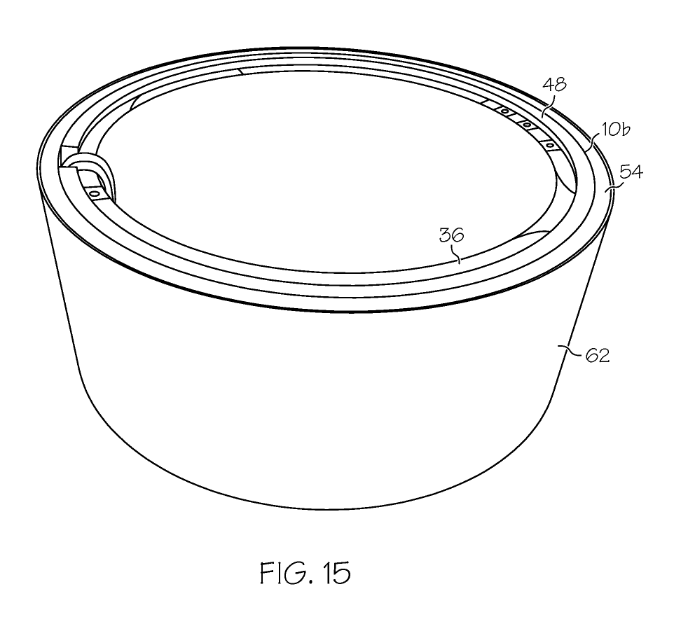

Referring now to FIGS. 12-15, in accordance with exemplary embodiments, an assembly sequence for forming the fan casing 26b of FIG. 8 begins by wrapping the at least one layer of the first crushable material radially outside and circumferentially around the fan containment case (not shown in FIG. 12). For ease of illustration, a single layer of the at least one layer of the first crushable material 48 is illustrated in FIGS. 13-15. The assembly sequence continues by wrapping the hybrid ballistic material 10b (FIGS. 2-6) circumferentially around the at least one layer of first crushable material (FIG. 12). Each of the horizontal filling lines 20a of the hybrid ballistic material 10b is disposed in the at least one groove 50 in the inner bonding surface 49 of the outermost layer of the at least one layer of first crushable material or the innermost layer of the at least one layer of second crushable material (The at least one groove 50 in FIG. 13 is illustrated in the outermost layer of the at least one layer of first crushable material 48.) The at least one groove 50 receives an individual member 12 or filling line 20a in a manner permitting intimate contact and bonding between at least the edges of the outermost layer of the at least one layer of the first crushable material and the innermost layer of the at least one layer of the second crushable material, i.e., each individual member 12 is received in the groove 50 such that the individual member/filling line does not protrude from the groove (not shown). As a practical matter, assembly is simplified if the at least one groove is in the outermost layer of the at least one layer of the first crushable material. The number, pattern, and spacing of the at least one groove corresponds to the number, pattern, and spacing of the at least one individual member 12 in the ballistic material 10b. The assembly sequence continues by wrapping the at least one layer of second crushable material 54 circumferentially around the ballistic material 10b (FIG. 14). Each of the at least one layer of first crushable material, the ballistic material 10b, and the at least one layer of second crushable material may be sequentially wrapped outside and circumferentially around the fan containment case in the manner illustrated in FIGS. 12-15 before bonding at least the edges of the outermost layer of the at least one layer of the first crushable material to the innermost layer of the at least one layer of the second crushable material with the ballistic material disposed therebetween forming the bonded assembly. For the hybrid ballistic material, the outermost layer of the at least one layer of the first crushable material and the innermost layer of the at least one layer of the second crushable material may be bonded at their edges. In an embodiment, the opposing ends 13 of the individual members 12 may be tied or otherwise fastened together at a prescribed tension to secure the bonded assembly circumferentially around the fan containment case (not shown in FIG. 14). As noted above, one or more layers of the first crushable material (in addition to the outermost layer being bonded to the innermost layer of the layer of second crushable material) may be bonded to each other and to one or more layers of the second crushable material. Similarly, one or more layers of the second crushable material may be bonded to each other and to layers of the first crushable material. The assembly sequence continues by continuously wrapping the multi-layered longitudinally folded structure 64a, the multi-layered diagonally folded structure 64b, the conventional containment covering (not shown), or a combination thereof outside and circumferentially around the outermost layer of the at least one layer of second crushable material forming the plurality of continuous layers 72 of the containment covering 62 (FIG. 15), representing the last step in the assembly sequence for the fan casing. The number of continuous layers is selected so that the containment covering contains the broken fan blade during impact and confines the broken blade to the predetermined circumferential envelope bounded by the inner surface of the engine nacelle. For example, an exemplary 3-ply multi-layered longitudinally folded structure wrapped radially outside and circumferentially around the outermost layer of the at least one layer of second crushable material three times under prescribed tension forms a containment covering having nine layers of the second ballistic fabric.

Referring again to FIG. 8 and now to FIG. 16, while assembly of the fan casing 26b has been described and illustrated, it is to be understood that the fan casing 26a including the net-like ballistic material 10a (FIG. 1) is assembled in the same manner. FIG. 16 illustrates the net-like ballistic material 10a disposed between the at least one layer of first and second crushable materials 48 and 54 (a single layer of first crushable material 48 and a single layer of second crushable material are illustrated in FIG. 16 for ease of illustration) in the bonded assembly 56 of the partially assembled fan casing 26a . For the net-like ballistic material, the outermost layer of the at least one layer of the first crushable material and the innermost layer of the at least one layer of the second crushable material may be bonded to each other across the face of the crushable material, in the mesh openings between the individual members as well as between edges thereof As noted above, one or more layers of the first crushable material, the second crushable material, or both the first and second crushable materials may also be bonded together and to a primary and secondary load path. The fan casing 26a (FIG. 8) will be completely assembled upon wrapping the multi-layered longitudinally folded structure, the multi-layered diagonally folded structure, or both in the plurality of continuous layers forming the containment covering 62 of the fan casing 26a . It is also to be understood that a conventional containment covering, alone or combination with the containment covering comprising one or both of the multi-layered longitudinally or diagonally folded structure may be used in the fan casing 26a.

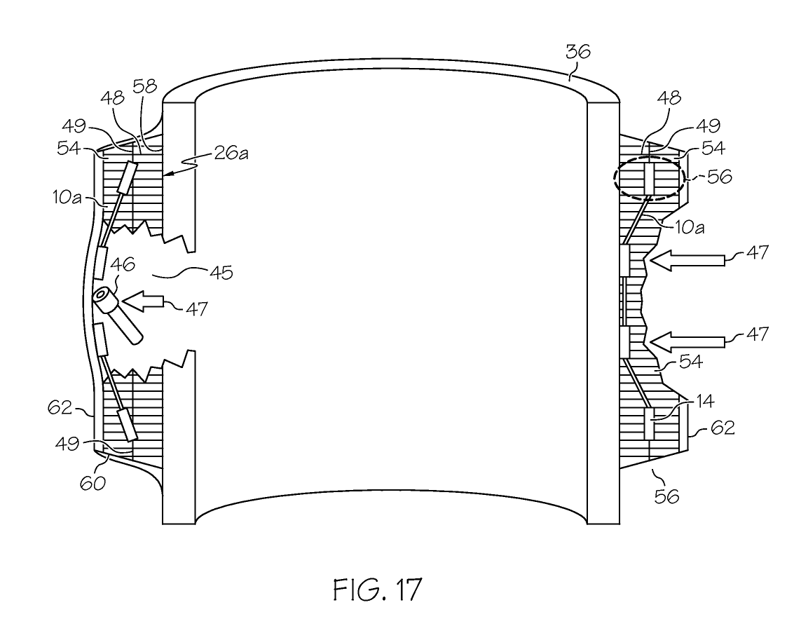

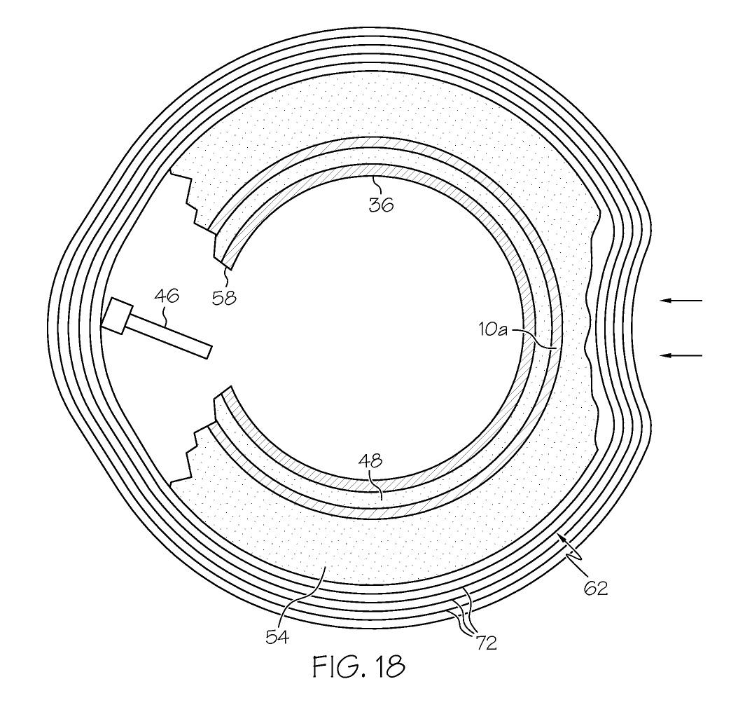

Referring now to FIGS. 17 through 20, in accordance with exemplary embodiments, the effects of blade impact on the fan containment case, bonded assembly, and the containment covering of fan casing 26a of FIG. 16 are shown. Referring now to FIG. 17, the broken blade impacts the fan casing 26a from inside the fan containment case. After penetrating the fan containment case at an impact location 45, the broken blade 46 crushes the first crushable material 48 and then impacts the ballistic material 10a. Crushing of the first crushable material with the broken blade reorients the broken blade and absorbs some energy from the blade impact. Upon impact, the broken blade stretches the unconstrained ballistic material 10a. The at least one individual member of the ballistic material engages the broken blade. The stretched ballistic material engages and crushes a local portion of the cross-sectional area of the second crushable material 54 as well as the first crushable material 48 opposite the impact location 45 as shown by the arrows 47. Thus, the ballistic material 10a stretches and absorbs energy circumferentially around the fan containment case. The longer stretch length of the ballistic material makes the effective length of energy absorption longer by spreading the load of the impact over a larger area without extending beyond the containment diameter (FIG. 18), thereby providing enhanced energy absorption upon impact of the broken blade.

Referring now specifically to FIG. 18, by locating the ballistic material 10a of the fan casing 26a in the mid plane between the outermost layer of the at least one layer of the first crushable material and the innermost layer of the at least one layer of the second crushable material forming the bonded assembly, the stretched ballistic material is pushed or pulled toward one or the other of the load paths and causes local disbonding between the at least one layer of the first and second crushable layers. Moreover, as the stretched ballistic material engages only a local portion of the cross-sectional area of the layers of crushable material, most of the first and second crushable material remains intact to continue to provide stiffening of the fan containment case between the primary and secondary load paths.

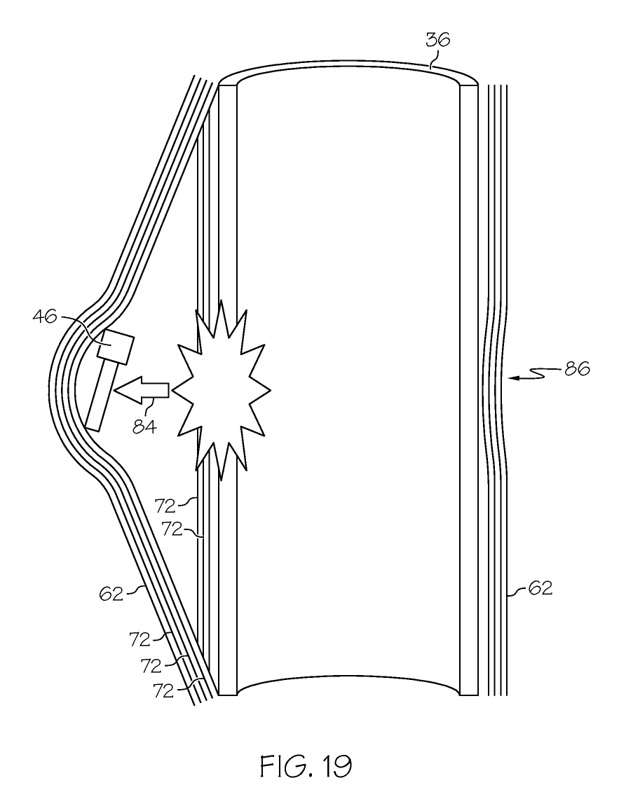

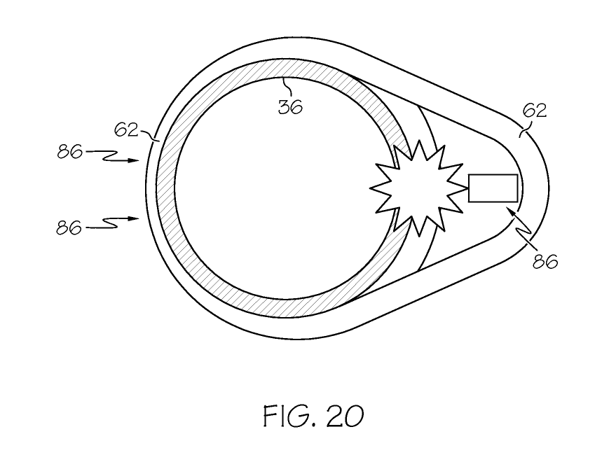

Still referring to FIG. 18, after the broken blade 46 locally crushes the second crushable material as illustrated in FIGS. 16 and 17, the broken blade is intercepted by the containment covering 62. Referring now to FIG. 19, the bonded assembly of fan casing 26a has been omitted for ease of illustration. The broken blade typically cuts through the plurality of continuous layers 72 of the containment covering 62, however at least one of the continuous layers remains intact. The impact of the broken blade stretches the at least one intact layer, with the intact layer(s) elongating and deflecting radially outwardly up to the circumferential envelope, as shown by the arrow 84 in FIG. 19. The broken blade is thus confined to the predetermined circumferential envelope bounded by the inner surface of the engine nacelle. Relatively low friction between the continuous layers of the containment covering and the unconstrained ends of the continuous layers 72 permit stretching of the containment covering over a longer length with a higher energy absorption all around the fan casing and the fan containment case as shown by the arrows 86 in FIGS. 19 and 20, rather than at the blade impact location only. The containment covering according to exemplary embodiments provides enhanced energy absorption, thereby enabling fewer continuous layers to be used in the fan casing and reducing the amount of second ballistic material thereof Thus, the weight and cost of the containment covering is reduced, thereby increasing aircraft operating efficiency.

While the effects of the impact of the broken blade on the fan casing 26a has been described and illustrated, it is to be understood that the broken blade impacts the fan casing 26b in the same manner with the ballistic material 10b and containment covering thereof providing enhanced energy absorption as previously described in connection with fan casing 26a . In addition, the at least one individual member 12 of both ballistic materials 10a and 10b also contributes to providing enhanced energy absorption. When the at least one individual member 12 of the ballistic material 10a and 10b engages the broken blade upon impact, the engaged individual members absorb and disperse the energy of the impact of the broken blade, transferring the energy to other individual members in the ballistic material. These individual members continue to absorb energy, also reducing the force of the impact. The ballistic material is also more resistant to cutting by the broken blade upon impact because of its relatively small surface to volume ratio. If the broken blade impacts the ballistic material 10a or 10b between individual members, the individual members are pulled toward the broken blade, resulting in better containment as more adjacent individual members are involved in containing the broken blade. Additionally, ballistic materials 10a and 10b will stretch over a relatively large area because of less friction and mechanical constraints, thereby increasing the total energy absorption.

While a fan casing comprising a ballistic material comprising a net-like ballistic material or a hybrid ballistic material and a containment covering comprising a multi-layered folded structure has been described (along with the at least one layer of the first and second crushable materials), it is to be understood that, in accordance with other exemplary embodiments, ballistic materials other than the net-like ballistic material or the hybrid ballistic material may be used in the fan casing with the containment covering comprising the multi-layered folded structure. For example, the ballistic material may be the bi-directional and multi-axial fabrics and fabric composites described in U.S. Pat. No. 6,841,492 issued Jan. 11, 2005 to the same assignee, and incorporated herein by reference. It is also to be understood that, in other embodiments for the fan casing, a conventional containment covering, alone or in combination with the multi-layered diagonally folded structure, the multi-layered longitudinally folded structure, or both, may be used with the net-like or hybrid ballistic material. As noted above and known to one skilled in the art, the conventional containment covering comprises a lightweight, high strength, and plain weave ballistic fabric. The conventional containment covering has no folds and may have open cut ends at the edges of the fabric.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A hybrid ballistic material comprising:
a first ballistic fabric; and
at least one individual member woven through at least a portion of the first ballistic fabric.

2. The hybrid ballistic material of claim 1, wherein the at least one individual member comprises a fabric strip, wire, cable, cord, rope, tape, or a combination thereof.

3. The hybrid ballistic material of claim 1, wherein the at least one individual member is woven through a plurality of openings in the at least a portion of the first ballistic fabric.

4. The hybrid ballistic material of claim 1, wherein the at least one individual member is woven through the at least a portion of the first ballistic fabric in a predetermined pattern.

5. The hybrid ballistic material of claim 4, wherein the at least one individual member comprises a plurality of individual members and the predetermined pattern comprises the plurality of individual members woven across the at least one portion of the first ballistic fabric forming spaced-apart horizontal filling lines extending parallel to longitudinal edges of the ballistic material.

6. The hybrid ballistic material of claim 4, wherein the at least one individual member comprises a plurality of individual members that intersect each other at crossover points to form a net-like array comprised of intersecting individual members, the intersecting individual members bonded together at the crossover points by mechanical means, chemical means, thermal means, or a combination thereof.

7. A fan casing for a fan containment case in a turbine engine, the fan casing comprising:
at least one layer of a first crushable material circumscribing the fan containment case;
a layer of ballistic material comprising one of a net-like ballistic material and a hybrid ballistic material, the layer of ballistic material circumscribing the at least one layer of the first crushable material;
a containment covering as an outermost layer.

8. The fan casing of claim 7, further comprising at least one layer of a second crushable material circumscribing the layer of ballistic material with the layer of ballistic material disposed between adjacent layers of the at least one layer of the first crushable material and the at least one layer of the second crushable material and the containment covering circumscribing an outermost layer of the at least one layer of the second crushable material.

9. The fan casing of claim 8, wherein the hybrid ballistic material comprises at least one individual member woven through at least a portion of a first ballistic fabric.

10. The fan casing of claim 9, wherein the at least one individual member is woven through a plurality of openings in the first ballistic fabric.

11. The fan casing of claim 9, wherein one of the adjacent layers includes at least one groove for receiving the at least one individual member to permit intimate contact and bonding between at least the adjacent layers, wherein at least a portion of the ballistic material is unconstrained between the adjacent layers.

12. The fan casing of claim 8, wherein the containment covering comprises a plurality of continuous fabric layers of a multi-layered longitudinally folded structure, a multi-layered diagonally folded structure, a non-folded containment covering, or combinations thereof.

13. The fan casing of claim 12, wherein the multi-layered longitudinally folded structure comprises a second ballistic fabric folded at least once at a longitudinal fold line parallel to an edge of the second ballistic fabric.

14. The fan casing of claim 12, wherein the multi-layered diagonally folded structure comprises a second ballistic fabric successively folded at diagonal fold lines at a specified bias angle to the warp or weft fibers of the second ballistic fabric.

15. The fan casing of claim 12, wherein the containment covering further comprises at least one restraining member running along at least one fold, at least one layer, or both, of the multi-layered longitudinally folded structure or the multi-layered diagonally folded structure.

16. A containment covering in a fan casing for a fan containment case in a turbine engine, the containment covering comprising:
a plurality of continuous fabric layers of a multi-layered longitudinally folded structure or a multi-layered diagonally folded structure, each of the multi-layered longitudinally and diagonally folded structures comprising:
a sheet of foldable ballistic fabric having two parallel spaced longitudinal edges, the sheet of foldable ballistic fabric successively folded at a selected angle; and
at least one restraining member.

17. The containment covering of claim 16, wherein the multi-layered longitudinally folded structure has at least one fold line parallel to the two parallel spaced longitudinal edges of the sheet of foldable ballistic fabric.

18. The containment covering of claim 16, wherein the multi-layered diagonally folded structure comprises the sheet of foldable ballistic fabric successively folded at diagonal fold lines at a specified bias angle of about 45° to the warp or weft fibers of the ballistic fabric.

19. The containment covering of claim 16, wherein the containment covering comprises an outermost layer of the fan casing, the fan casing further comprising:
at least one layer of a first crushable material circumscribing the fan containment case; and
a layer of ballistic material comprising a net-like ballistic material, a hybrid ballistic material, or a bi-directional or multi-axial fabric or fabric composite, the ballistic material circumscribing the at least one layer of the first crushable material.

20. The containment covering of claim 19, wherein the fan casing further comprises at least one layer of a second crushable material circumscribing the layer of ballistic material.
